(19) United States
(12) Patent Application Publication
(10) Pub. No.: US 2014/0078931 A1
(43) Pub. Date: Mar. 20, 2014

(54) Wireless Communication Device, Wireless Communication System, And Wireless Communication Control Method

(71) Applicant: Hitachi, Ltd., Tokyo (JP)

(72) Inventors: Yasutaka SERIZAWA, Tokyo (JP); Masayuki MIYAZAKI, Tokyo (JP); Makoto KATAGISHI, Chigasaki (JP)

(73) Assignee: Hitachi, Ltd., Tokyo (JP)

(21) Appl. No.: 13/903,458

(22) Filed: May 28, 2013

(30) Foreign Application Priority Data
Sep. 14, 2012 (JP) 2012-202214

(51) Int. Cl. H04W 52/02

(52) U.S. Cl. CPC H04W 52/0216
USPC 370/254

(57) ABSTRACT

A wireless communication system is configured such that, during a period in which wireless communication is being performed between first and second wireless access points, wireless communication in a first wireless communication sub-network and a second wireless communication sub-network is made to stand by, and during the time other than the period in which wireless communication is being performed, wireless communication in at least one of the first wireless communication sub-network and the second wireless communication sub-network is performed.

This application claims the priority of Japanese Patent Application No. JP 2012-202214, filed Sep. 14, 2012, the disclosure of which is expressly incorporated by reference herein in its entirety.

### BACKGROUND OF THE INVENTION

1. Field of the Invention

The present invention relates to a wireless communication device, a wireless communication system, and a wireless communication control method.

2. Background Art

In recent years, with a rise in awareness of environmental problems and institutionalization, there is an increasing technical need for energy management. On the side of consumers who consume energy, an energy management system (EMS), such as a home energy management system (HEMS) in which energy management is performed at home, a building energy management system (BEMS) in which energy management is performed at an apartment house or a building, or a city energy management system (CEMS) in which energy management is performed in an area of a community, is expected. On the side of electric power companies which generate energy, a smart meter or an advanced metering infrastructure (AMI) in which automatic reading of a power meter is performed, or a smart grid for stabilizing a power distribution/transmission system is required. There is also a study on the concept of a smart city in which these techniques are collectively applied in a city area.

In order to realize an energy-related management system, it becomes essential to secure the infrastructure of communication means. As the communication means, there are various options, such as wireless communication, wired communication, optical communication, and power line communication, and optimum means is selected depending on an environment which is constructed as the infrastructure. Of these, wireless communication is excellent from the viewpoint of ease of installation and maintenance, low-cost devices, ease of expansion, and the like, and is highly expected.

When wireless communication is used as the communication infrastructure means, an installation environment should also be taken into consideration and optimization is required depending on the purposes. For example, in regard to the smart meter in the AMI, there is a need for allowing multiple wireless terminals to perform communication regularly (every 30 minutes or the like) in a comparatively close area within several 100 m or 1 km. In the smart grid, when emergency communication is required, it is necessary to perform communication at a high speed (low latency or short time) over a long distance of about 10 km. Examples of emergency communication include short-circuiting due to electric wire breakage, an emergency stop instruction of power distribution, and the like.

Of the background, in the related art, as disclosed in the following patent literatures, wireless techniques for optimally realizing an AMI wireless network have been developed, and multiple demonstration experiments have been carried out. Practically, however, read data from the AMI wireless network should be transmitted to the electric power company through the smart grid wireless network, and control information or an emergency instruction from the electric power company should be transmitted through the smart grid wireless network and the AMI wireless network. For this reason, a wireless communication scheme which can integrate a plurality of wireless networks having different requested specifications or features, such as the smart grid wireless network and the AMI wireless network, in a single wireless network is required.

JP-A-2012-015897 discloses a technique which constructs an optimum communication root on the basis of link metric information between wireless nodes in a mesh network centering on a wireless gateway.

JP-A-2009-188469 discloses a technique which performs transmission/reception only for a given period of time in a given cycle in an ad-hoc network and a mesh network to enable a network with low power consumption in an asynchronized communication scheme.

### SUMMARY OF THE INVENTION

An object of the invention is to enable wireless communication between a plurality of independent ad-hoc wireless networks and multi-hop wireless networks in a wireless communication network.

In the related art, in one ad-hoc or multi-hop wireless network, a technique for optimizing communication reliability, power consumption, the number of connected transceivers, low cost, and the like depending on the purposes has been studied and developed. However, when there is a plurality of ad-hoc or multi-hop wireless networks, and communication should be performed between the wireless networks, since there is no common communication protocol between the wireless networks, it is not possible to realize wireless communication between the wireless networks.

That is, the invention has been accomplished in consideration of the problems in the related art, and an object of the invention is to provide a wireless communication device, a wireless communication system, and a wireless communication control method which enable the realization of a plurality of ad-hoc/multi-hop networks (sub-networks) in a wireless communication network and an ad-hoc/multi-hop network (main network) connecting the sub-networks using a single wireless protocol. Another object of the invention is to prevent wireless communication of sub-networks from affecting communication quality of other main networks and sub-networks in realizing the above-described object.

A wireless communication device, a wireless communication system, and a wireless communication control method of the invention for solving the above-described problems have the following means.

The features of the invention are as follows.

An access point (AP) is arranged in at least one of wireless communication devices in each sub-network, and a main network is configured between the APs to realize communication between a plurality of sub-networks. Since the main network is a main system, and there is a high probability that high-priority communication is occurred, a communication opportunity between the APs is preferentially secured in accordance with a wireless application specification. Besides, each AP allocates the time other than the communication opportunity between the main networks to the communication time between the sub-networks to which the AP belongs.

When the AP performs communication between the main networks, the start time of carrier sense (a structure in which radio power strength around the wireless device is measured to determine the presence/absence of a transmission radio wave, and if there is a transmission radio wave, radio wave transmission is delayed to avoid packet collision) immediately before radio wave transmission is set to be smaller than the start time of carrier sense of the wireless communication devices in the sub-network, thereby placing priority on communication between the main networks by the AP.

According to the invention, it is possible to provide a wireless communication device, a wireless communication system, and a wireless communication control method which enable the realization of a plurality of ad-hoc/multi-hop networks (sub-networks) in a wireless communication network and an ad-hoc/multi-hop network (main network) connecting the sub-networks using a single wireless protocol. It is also possible to provide a wireless communication network system which enables wireless communication in which main network communication by the AP is placed priority and prevents wireless communication of one sub-network from affecting communication quality of other main networks and sub-networks.

### BRIEF DESCRIPTION OF THE DRAWINGS

FIG. 1 shows a network configuration example according to the invention.

FIG. 2 shows a data transmission procedure (in case of CSMA).

FIG. 3 shows a data transmission procedure (in case of TDMA).

FIG. 4 shows a transceiver configuration of an AP and a wireless node ND in Example 1.

FIG. 5 shows a communication time chart example (main network) (when a sub-network is asynchronous (CSMA)).

FIG. 6 shows a communication time chart example (sub-network 11) (when a sub-network is asynchronous (CSMA)).

FIG. 7 is an operation flowchart (1) of an AP of Example 1.

FIG. 8 shows a transceiver configuration (2) of an AP and a wireless node ND in Example 2.

FIG. 9 shows a communication time chart example (main network) (when a sub-network is synchronous (TDMA)).

FIG. 10 shows a communication time chart example (sub-network 11) (when a sub-network is synchronous (TDMA)).

FIG. 11 is an operation flowchart (2) of an AP in Example 2.

FIG. 12 shows packet priority control (1) by reduction in carrier sense time (in case of CSMA).

FIG. 13 shows packet priority control (2) by reduction in carrier sense time (in case CSMA).

FIG. 14 shows packet priority control (1) by reduction in carrier sense time (in case of TDMA).

FIG. 15 shows packet priority control (2) by reduction in carrier sense time (in case of TDMA).

FIG. 16 shows a communication time chart example (sub-networks 11 and 12)-1 (when each sub-network independently performs communication by TDMA).

FIG. 17 shows a communication time chart example (sub-networks 11 and 12)-2 (when each sub-network independently performs communication by TDMA).

FIG. 18 is an operation flowchart (3) of an AP in Example 5.

FIG. 19 shows a communication time chart example (sub-networks 11 and 12)-3 (when each sub-network independently performs communication by TDMA).

FIG. 20 shows a communication time chart example (sub-networks 11 and 12)-1 (when each sub-network independently performs communication by an asynchronized scheme (CSMA)).

FIG. 21 shows a communication time chart example (sub-networks 11 and 12)-2 (when each sub-network independently performs communication by an asynchronized scheme (CSMA)).

FIG. 22 is an operation flowchart (4) of an AP in Example 8.

### DESCRIPTION OF EMBODIMENTS

Hereinafter, a wireless communication device, a wireless communication system, and a wireless communication control method according to the invention will be described in detail referring to an embodiment shown in the drawings.

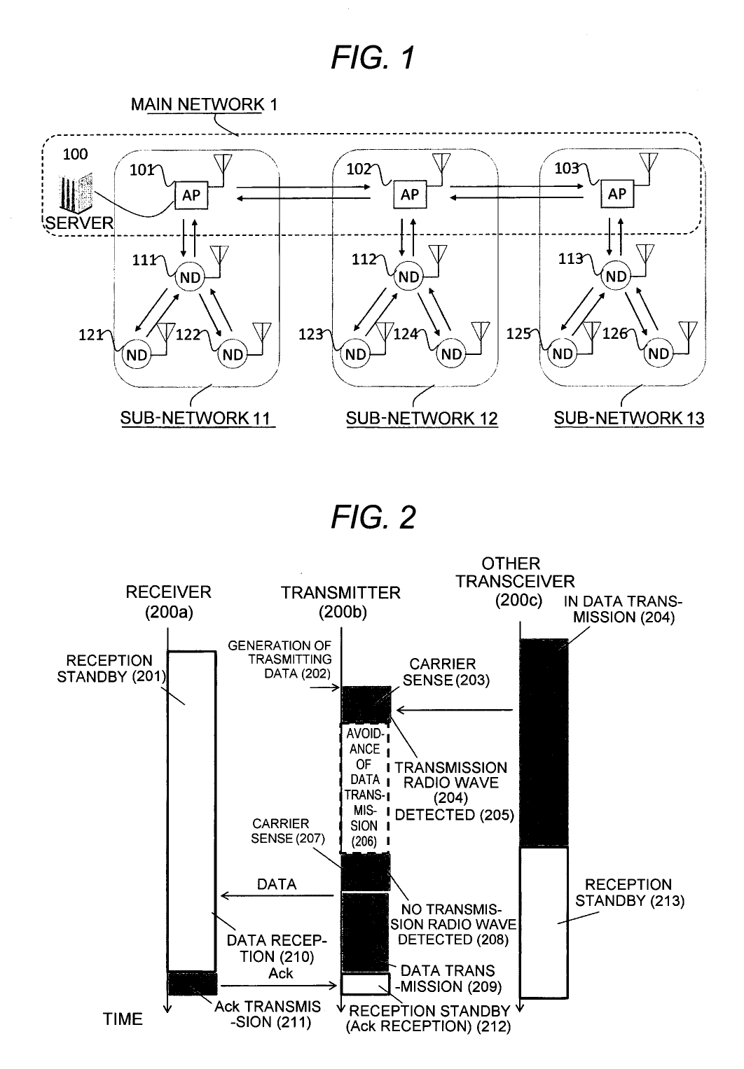

FIG. 1 shows a wireless communication network configuration of this example. A wireless communication network of this example includes a server 100, wireless access points APs 101, 102, and 103, and wireless nodes NDs 111 to 113 and 121 to 126, and NDs 111 to 113 double as wireless rooters. The AP 101 and the NDs 111, 121, and 122 configure a sub-network 11, the AP 102 and the NDs 112, 123, and 124 configure a sub-network 12, the AP 103 and the NDs 113, 125, and 126 configure a sub-network 13, and the server 100 and the APs 101, 102, and 103 configure a main network 1. In this example, it is assumed that wireless communication is performed along a path shown in FIG. 1.

The network configuration example shown in FIG. 1 assumes a communication network which is associated with a smart grid power distribution network and an AMI network, and the main network 1 is required for communication over a long distance (equal to or smaller than 10 km) with low latency (for example, 10 s) mainly with multiple hops as the smart grid wireless network.

The server 100 installed in a substation or the like is connected to the higher level of the main network 1, and in the server 100, power read information from each sub-network is collected through the AP installed in an electric pole, and signals, such as a power control signal and an emergency instruction, according to the read information are transmitted to a controlled device, such as a switch, through the AP. The ND assumes a smart meter, and a sub-network covers a close distance (about 100 m to 1 km) at a communication interval of 30 minutes as an AMI wireless network. The power read information is collected from the smart meter to the AP and the server by the ad-hoc/mesh network, and the AP preferentially transmits control information from the server to a controlled device, such as a household electrical appliance.

Hereinafter, a communication procedure by a career sense multiple access (CSMA) scheme and a communication procedure by a time division multiple access (TDMA) scheme which are commonly used in Examples will be described. In general, since the CSMA scheme is a simple protocol, while functional mounting is eased, packet collision is likely to occur. While the TDMA scheme is complicated and requires the number of man-hour for functional mounting, packet management can be performed, thereby avoiding packet collision.

### Data Transmission/Reception Procedure by CSMA Scheme

In the CSMA scheme, carrier sense is performed immediately before data transmission, and radio power strength is measured to check whether or not the other wireless device is transmitting data. If no radio wave of the other wireless device is detected, data is transmitted as scheduled.

If a radio wave of the other wireless device is detected, scheduled data transmission is cancelled, and retransmission is performed in the next transmission opportunity. Accordingly, it is possible to avoid packet collision due to the matching of the data transmission timing.

In the CSMA scheme, the period in which carrier sense is performed is set to be random in each transmission opportunity.

FIG. 2 shows an example of a data transmission/reception procedure in the career sense multiple access (CSMA) scheme. In FIG. 2, a receiver 200a is kept in a reception standby state (201), and prepares for data reception. If transmitting data is generated (202), a transmitter 200b immediately performs carrier sense (203). In the example of FIG. 2, since a transceiver 200c is in data transmission (204) when transmitting data of the transmitter 200b is generated (202), a transmission radio wave is detected by carrier sense (203) of the transmitter 200b (205).

For this reason, the transmitter 200b avoids scheduled data transmission (206), stands by the completion of data transmission of the transceiver 200c, performs carrier sense (207), and then perform data transmission again (209). Since the receiver 200a is in the reception standby state (201), data transmission (209) of the transmitter can be received. The transmitter 200b is changed to a reception standby state (212) in a short time after data transmission (209) and stands by a response (Ack. This means an acknowledge signal. The same applies to the following) from the receiver 200a. If data reception (210) is completed, the receiver 200a immediately transmits Ack (211), the transmitter 200b receives Ack (212), and communication is completed.

In the CSMA mode, during a period other than carrier sense, data transmission, Ack transmission, and the data transmission avoidance period, reception standby is performed to prepare for data reception.

### Data Transmission/Reception Procedure by TDMA Scheme

In the TDMA scheme, transmission/reception of a packet for synchronization (Adv: Advertise) between the transmitter and the receiver is preformed regularly to perform time synchronization between the transmitter and the receiver, and communication is performed while matching the communication timing.

For this reason, as in the CSMA scheme, there is an advantage in that packet collision or transmission delay due to a transmission radio wave of the other transceiver in the host system does not occur.

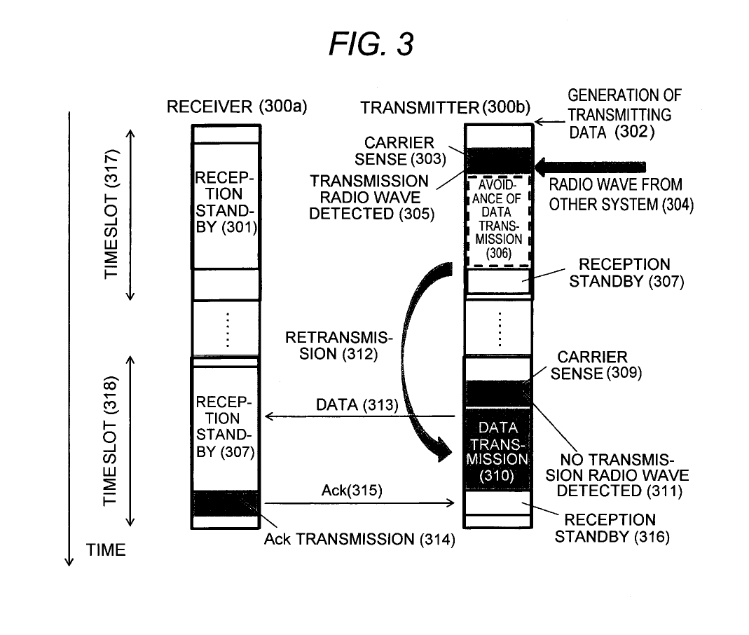

FIG. 3 shows an example of a data transmission/reception procedure in the time division multiple access (TDMA) scheme. In the example of FIG. 3, in timeslots 317 and 318, a receiver 300a performs a reception operation, and a transmitter 300b performs a transmission operation. The start time and the end time of the timeslot are shared by the receiver 300a and the transmitter 300b by sharing of a packet for time synchronization.

The receiver performs reception standby for a given time in the timeslots 317 and 318 ((301), (308)), when there is no data reception (301), is changed to the next timeslot directly, and when there is data reception (308), transmits Ack at the end of the timeslot (314).

If transmitting data is generated (302), for example, the transmitter 300b performs carrier sense over a given period in the timeslots 317 and 318 ((303), (309)), when no radio wave is detected (311), performs data transmission (310), and when a radio wave is detected (305), avoids scheduled data transmission (306).

Reception standby is performed in a short time at the end of the timeslot ((307), (316)), and Ack is received from the receiver 300a. In the example shown in FIG. 3, while the transmitter 300b attempts data transmission to the receiver 300a in the timeslot 317, since a radio wave (304) from the other system is detected (305), data retransmission (313) is performed in the timeslot 318 as the next transmission/reception opportunity.

A repetition cycle of communication having a plurality of timeslots is referred to as a superframe.

Hereinafter, Examples will be described in detail referring to the drawings. While the carrier sense time immediately before data transmission is not shown unless particularly required, in Examples, it is assumed that carrier sense immediately before data transmission is performed.

### EXAMPLE 1

This example illustrates an example of the invention when transmission/reception of a packet for time synchronization (Adv) is performed between the server 100 and the AP 101, 102, or 103 in the main network of FIG. 1, whereby time synchronization is established.

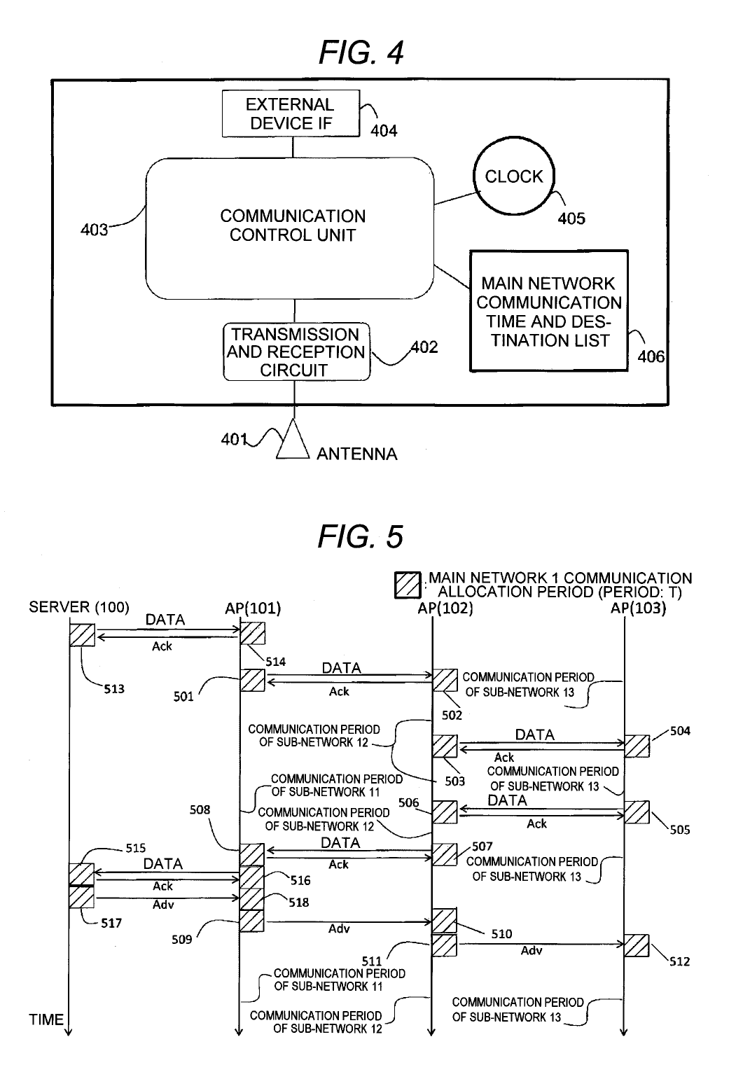

FIG. 4 shows a configuration example of a transceiver of an AP and an ND in this example. The configuration may be common to the AP and the ND. The transceiver has an antenna 401, a transmission and reception circuit 402, a communication control unit 403, an external device IF 404, a clock 405, and a main network communication time and destination list (406) stored in a memory. The communication control unit 403 instructs the transmission and reception circuit 402 to perform data transmission/reception processing on the basis of the time of the clock 405 in accordance with the main network communication time and destination list 406 to be referenced by the communication control unit 403, and performs transmission/reception of signals from the antenna 401.

FIG. 5 shows an example of a communication timing chart in the main network 1. In this example, while communication by the TDMA mode is performed in the main network 1, communication in the CSMA mode is performed in the sub-network 11, 12, or 13. That is, it is assumed that power read information which is aggregated in the AP through the AMI wireless network performing asynchronized communication by the CSMA scheme is collected by the smart grid wireless network of the TDMA scheme.

In FIG. 5, the server 100 and the APs 101, 102, and 103 set a communication allocation period for the main network 1 (501 to 518), communication to a sub-network is stopped in the main network communication period (501 to 518), and communication with an AP registered in advance is performed at the time registered in advance in the main network communication time and destination list 406. The list 406 may be registered in advance and used, or may be rewritten through communication and used. Data reception/Ack return from the server 100 is performed in the main network 1 communication period (514), and the AP 101 transmits data to the AP 102 and receives Ack in the main network 1 communication period (501). In the main network communication period (508), data from the AP 102 is received and Ack is returned.

In the main network communication period (509), the packet for time synchronization (Adv) is transmitted to the AP 102 to perform time synchronization. Communication by the CSMA scheme is performed using an unoccupied time between the main network communication periods (501, 508, and 509) as a sub-network 11 communication period.

For the server 100, the AP 102, and the AP 103, similarly, communication with an AP is performed in the main network 1 communication period. For the AP 102 and the AP 103, the unoccupied time between the main network communication periods is allocated to the communication periods of the sub-networks 12 and 13.

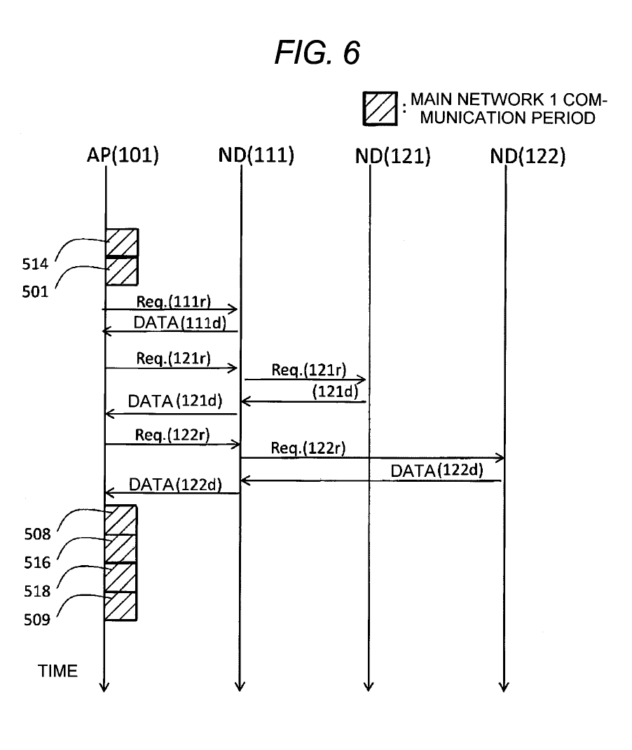

FIG. 6 shows an example of a communication time chart of the sub-network 11 communication period of the AP 101 in FIG. 5.

While FIG. 6 shows an example of communication of the sub-network 11 in the CSMA mode, a polling scheme in which each ND transmits data to the AP 101 in response to a data request (Req.) from the AP 101 such that communication of the sub-network can be stopped in the main network 1 communication period is used.

In the polling scheme, the data request (Req.) is transmitted to an ND, and only the ND which receives Req. can transmit data. The AP 101 transmits Req. to the next ND first when data reception from the ND is completed. Description will be provided on the basis of the example of FIG. 6. The AP 101 receives data from the server 100 in the main network communication period 514, and performs communication with the AP 102 in the main network communication period 501. Next, Req. (111r) is transmitted to the ND 111, and the ND 111 which receives Req. (111r) transmits data (111d) to the AP 101. After reception of data (111d) is confirmed, the AP 101 transmits Req. (121r) to the ND 121 through the ND 111, and acquires data (121d) of the ND 121. Thereafter, after data (122d) of the ND 122 is received, the AP 101 performs communication of data and Adv with the AP 102 in the main network 1 communication periods 508 and 509, and performs communication of data and Adv to the server 100 in the main network communication periods 516 and 518.

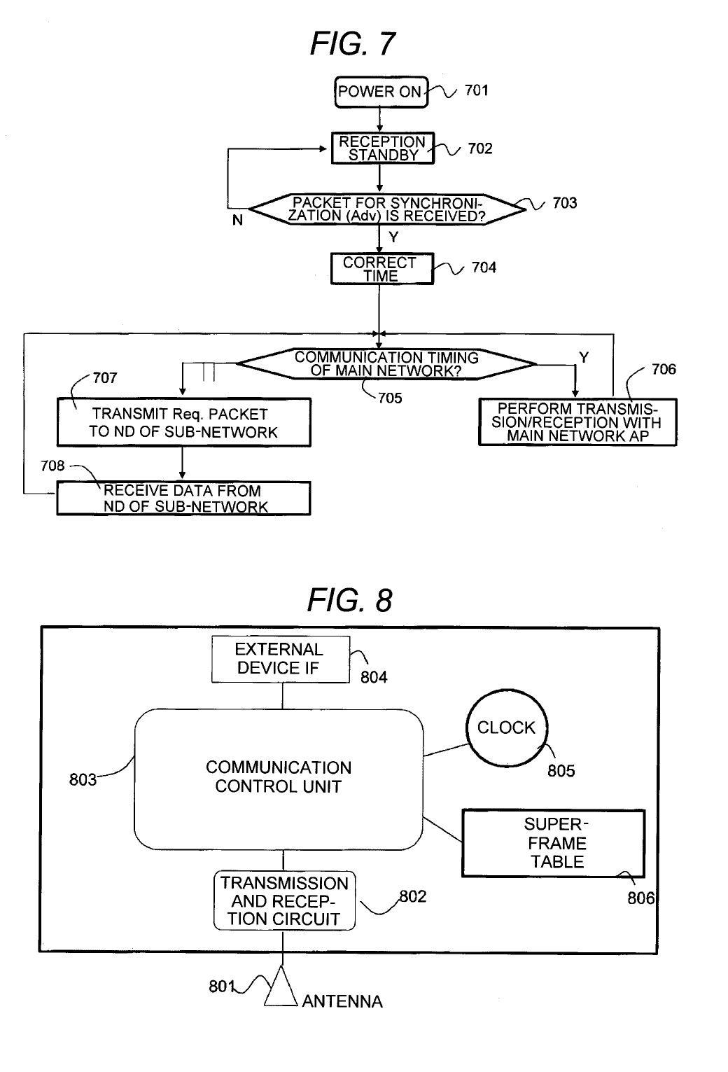

FIG. 7 is an operation flowchart of an AP in this example. If power is applied (701), an AP is changed to reception standby (702) and repeats a reception state (702) and Adv reception presence/absence determination (703) until the packet for synchronization (Adv) is received (703). If the Adv packet is received, the clock 405 is corrected (704) on the basis of the time included in the Adv packet.

Thereafter, the procedure is changed to a loop of communication processing, and it is confirmed whether or not the main network communication timing is reached (705) referring to the main network communication time and destination AP list 406 which is referenced to by the communication control unit 403. If the main network communication timing is reached, data transmission/reception with the AP in the main network is performed in accordance with the list 406, and if the main network communication timing is not reached, the Req. packet is transmitted to the ND of the sub-network 11, 12, or 13 (707).

If the reception of data from the ND of the sub-network 11, 12, or 13 is completed, the procedure is changed again to main network communication timing determination (705).

### EXAMPLE 2

In this example, a case where communication in the sub-network 11, 12, or 13 in Example 1 is performed by the TDMA scheme will be described.

FIG. 8 shows a transceiver configuration example of an AP and an ND when this example is carried out. Although 801 to 805 are the same as in Example 1, in this example, a communication control unit 803 references a superframe table 806. A superframe is defined as a repetition unit of communication having a plurality of timeslots. The superframe table 806 describes the operation of each timeslot, the type of transmission or reception of each timeslot, and address information of a communication party. The communication control unit 803 references the superframe table 806 when the power is turned on, and repeats the operation defined in the superframe table 806.

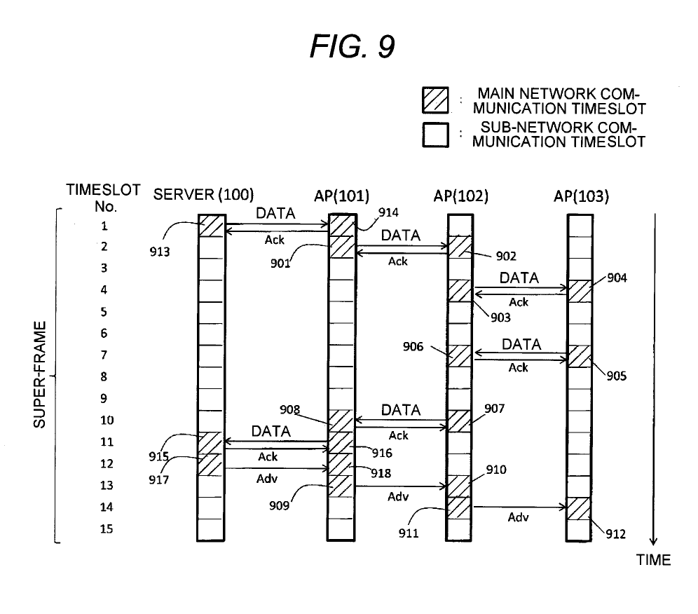

FIG. 9 shows a superframe configuration of the server 100 and the APs 101, 102, and 103 and a communication time chart in the main network 1. In the superframes of the server 100 and each AP, the main network communication timeslots (901 to 918) are allocated to perform data transmission/reception. In the AP, it is assumed that other timeslots are the communication timeslots of the sub-networks 11, 12, and 13. For example, as shown in FIG. 9, in the superframe configuration of the AP 101, data communication with the server 100 is allocated in the timeslot Nos. 1 and 11, data communication to the AP 102 is allocated in the timeslot No. 2, communication with the ND in the sub-network 11 is allocated in the timeslots Nos. 3 to 9, 14, and 15, data reception from the AP 102 is allocated in the timeslot No. 10, and Adv reception from the server 100 and Adv transmission to the AP 102 are allocated in the timeslots Nos. 12 and 13. The superframe configuration, the communication timing, and the transmission/reception ND of FIG. 9 are an example for illustrating this example and may be changed.

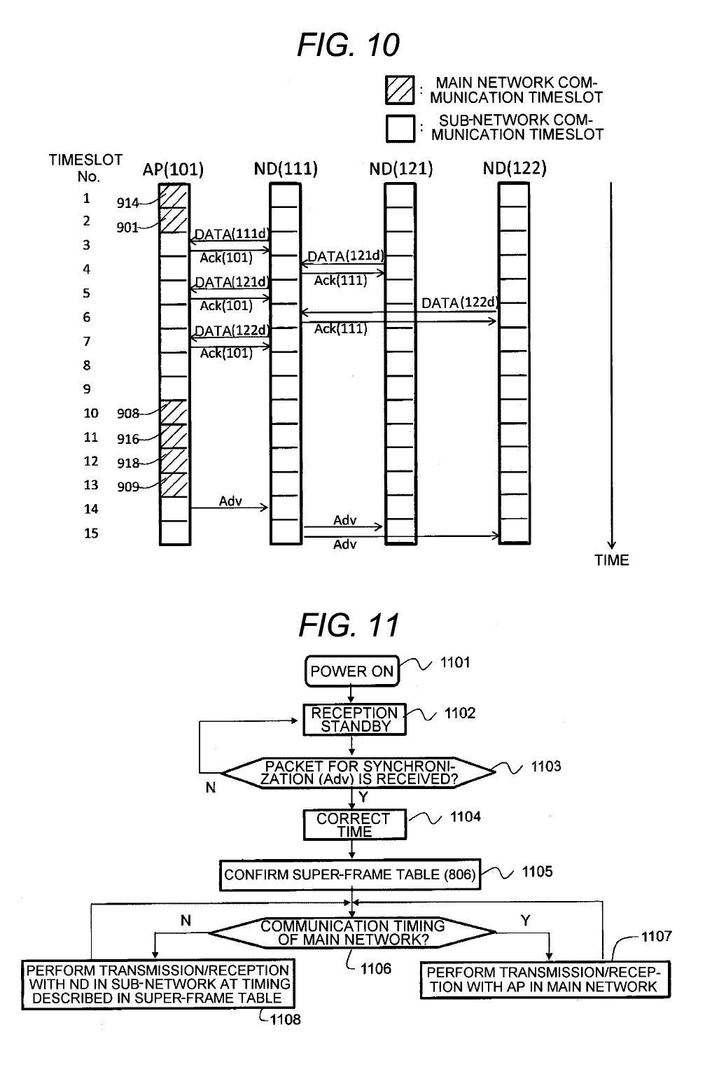

FIG. 10 shows a communication time chart in the sub-network communication timeslot of FIG. 9 using the sub-network 11 belonging to the AP 101 as an example.

In this example, since the sub-network uses the TDMA scheme, communication of the sub-network 11 does not affect communication of the main network 1. For this reason, FIG. 10 shows an example where the ND spontaneously transmits data to the AP 101 at a set time.

The ND 111 transmits data (111d) to the AP 101 in the timeslot No. 3, receives data (121d) from the ND 121 in the timeslot No. 4, and transfers data (121d) to the AP 101 in the timeslot No. 5. Data (122d) of the ND 122 is received by the ND 111 in the timeslot No. 6, and is transferred to the AP 101 in the timeslot No. 7.

The packet for time synchronization (Adv) is broadcasted from the AP 101 to the ND in the timeslots No. 14 and 15. The superframe configuration, the communication timing, and the transmission/reception ND of FIG. 10 are an example for illustrating this example, and may be changed.

FIG. 11 is an operation flowchart of an AP for realizing this example.

If the power is turned on (1101), the AP is changed to reception standby (1102) and receives the packet for synchronization (Adv) (1103). If the packet for synchronization (Adv) is received, the superframe table 806 is confirmed (1105), and a communication schedule is determined. Thereafter, it is confirmed whether or not the present time is the main network communication timing described in the superframe table 806 (1106), when the main network communication timing is reached, signal transmission/reception with the AP in the main network is performed (1107), and when the main network communication timing is not reached, communication with the ND in the sub-network is performed as described in the superframe table 806.

### EXAMPLE 3

In this example, a method which, when transmitting emergency data or a device control command from the server 100 of FIG. 1 to the ND through the main network 1 and the sub-network in Example 1, preferentially transmits emergency data or a device control command in the sub-network and send emergency data or a device control command to the destination ND with low latency will be described. Specifically, it is assumed that priority data is transmitted from the AP 101 to the ND at an arbitrary timing during communication of FIG. 6.

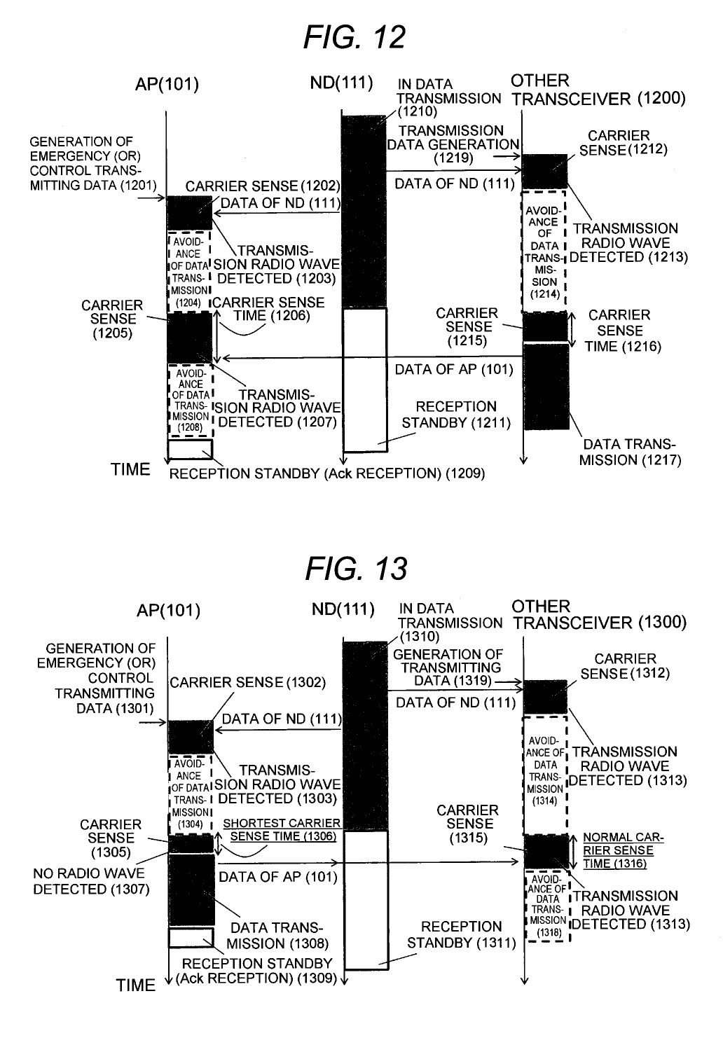

FIGS. 12 and 13 illustrate a structure of packet priority control in the CSMA scheme.

FIG. 12 shows an example of a communication flow when priority control is not performed in transmitting data from the AP 101 to the ND 111. In FIG. 12, the AP 111 generates emergency (or) control transmitting data (1201) in data transmission of the ND 111, and the other transceiver 1200 in the system generates transmitting data (1219).

The other transceiver (1200) may be the ND in the same sub-network 11 as the ND 111, or may be the AP or the ND in the other sub-network. In this case, both the AP 101 and the other transceiver 1200 avoid data communication (1204) and (1214) with carrier sense (1202) and (1212), and enter a retransmission process simultaneously after data transmission of the ND 111 ends.

While carrier sense is performed immediately before data transmission in the retransmission process, the carrier sense time is set to be random so as to give the same transmission probability to all transceivers.

Accordingly, as shown in FIG. 12, there is the difference in the carrier sense time between the AP 101 and the other transceiver 1200. FIG. 12 shows a case where the carrier sense time (1206) of the AP 101 is set to be greater than the carrier sense time (1216) of the other transceiver. In this case, since data transmission (1217) of the other transceiver 1200 is transmitted ahead of emergency (or) control transmitting data of the AP 101 having high priority, a transmission radio wave is detected (1207) in carrier sense (1205) of the AP 101, and transmission of priority data of the AP 101 is avoided again.

Accordingly, in FIG. 13, in carrier sense (1305) of the AP 101, the shortest carrier sense time (1306) which is smaller than the normal carrier sense time (1316) is set as the carrier sense time, whereby data transmission (1308) of the AP 101 can be preferentially performed earlier than the other transceiver 1300, and packet collision with the other transceiver 1300 can be avoided. That is, in emergency or at the time of transmission of high-priority data, such as control data, the carrier sense time at the time of transmission is set to be shortest compared to the transceiver in the system, thereby performing priority control.

### EXAMPLE 4

In this example, a method which, when transmitting priority data, such as emergency data or a device control command, from the server 100 of FIG. 1 to the AP through the main network 1 in Example 2, sends priority data to the destination AP in the main network with low latency will be described.

There is a case in which communication between the AP 102 and the AP 103 is delayed due to radio wave interference from the ND in the sub-network 11 during communication between the AP 102 and the AP 103 in FIG. 1.

Specifically, when the AP 102 transmits priority data to the AP 103 in a communication allocation period (903) (timeslot No. 4) of the main network 1 of the AP 102 of the FIG. 9, as in the timeslot No. 4 of FIG. 10, the ND 121 in the sub-network 11 transmits a radio wave simultaneously with the AP 102, and there is a possibility that collision with priority data from the AP 102 to the AP 103 occurs.

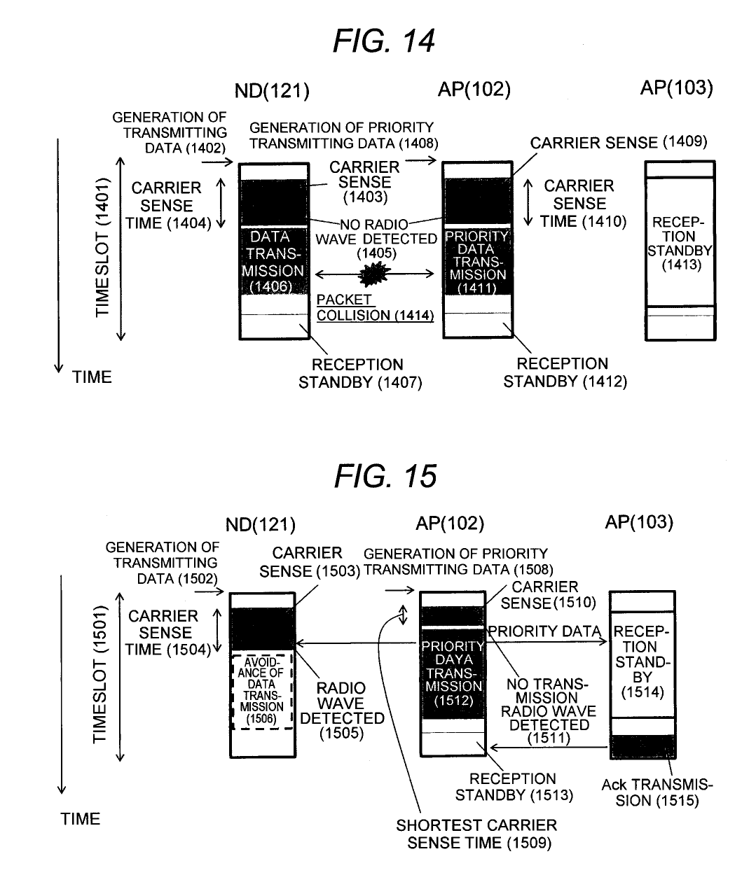

FIG. 14 shows an example where packet collision occurs.

The ND 121 and the AP 102 perform carrier sense (1403) and (1409) immediately before transmission when executing the generation of transmitting data (1402) and priority transmitting data (1408) in the timeslot (1401).

In the TDMA scheme, since the carrier sense time (1404) and (1403) is constant, both the ND 121 and the AP 102 determine that no radio wave is detected (1405) in carrier sense, and thus transmit data simultaneously (1406) and (1411). For this reason, packet collision (1414) occurs.

Accordingly, when performing communication between the AP 102 and the AP 103, as shown in FIG. 15, the shortest carrier sense time (1509) is used in carrier sense (1510) of the transmission side (AP 102), whereby priority data transmission (1512) of the AP 102 can start in the middle of carrier sense (1503) of the ND 121, and data transmission of the ND 121 can be thus avoided (1506).

For this reason, it is possible to reduce transmission delay of the main network due to interference of a communication radio wave of the sub-network.

### EXAMPLE 5

This example illustrates an example of the invention when time synchronization by the transmission/reception of the packet for time synchronization (Adv) is not established between the server 100 and the AP 101, 102, or 103 in the main network of FIG. 1, and each sub-network independently performs communication by the TDMA scheme. A transceiver configuration of an AP and an ND in this example is shown in FIG. 8, and is the same as in Example 2.

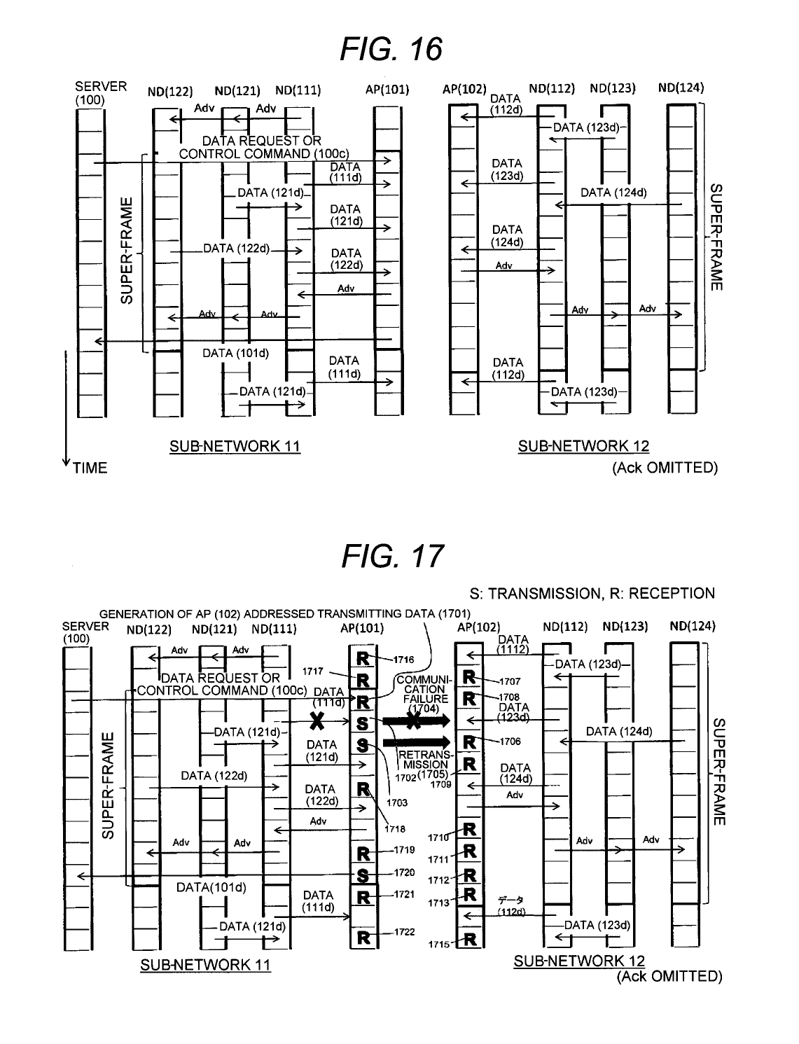

FIG. 16 shows a superframe configuration and a communication time chart of the sub-network 11 and the sub-network 12. Transmission/reception allocation in a superframe and a communication party are as shown in FIG. 16. In each sub-network, the ND transmits and transfers data to the AP in an allocated timeslot, and the AP receives data from the ND in a determined timeslot of a superframe.

In this example, since the sub-network 11 and the sub-network 12 independently uses the TDMA scheme, the time between the sub-network 11 and the sub-network 12 is asynchronous, and the superframe length is different.

For this reason, it is not possible to configure the main network by connecting the sub-networks together.

Accordingly, the sub-network 11 and the sub-network 12 are connected together by means shown in FIG. 17 to configure the main network. The superframes of the AP 101 and the AP 102 describe the transmission/reception timeslots of the ND 111 and the ND 112, all unoccupied timeslots are allocated to “reception (R)” and stored in the superframe table 806 (1701, 1707 to 1722).

Besides, for example, when transmitting data addressed to the AP 102 is generated (1701) in the AP 101, the communication control unit 803 rewrites the superframe table 806 so as to transmit (S) (1702, 1703) data to the AP 102 successively after the next timeslot (1702).

When this happens, data transmitted to the AP 102 in the timeslot (1702) undergoes communication failure because the AP 102 is not in the reception (R) mode of data from the AP 101. Meanwhile, in regard to transmitting data which is transmitted to the AP 102 in the timeslot (1703), since the AP 102 is in the reception (R) mode, transmission/reception is established.

Accordingly, communication through the main network can also be performed between the sub-networks which independently configure a wireless network by the TDMA scheme.

However, similarly to the timeslot (1702), when a timeslot allocated to data reception from the ND 111 is written to transmission (S), the AP 101 performs carrier sense for a radio wave of data (111d), and there is a possibility that transmission to the AP 101 in the same timeslot is cancelled. For this reason, the shortest carrier sense time (1509) in FIG. 15 described in Example 4 is set at the time of transmission of the AP (101), whereby transmitting data addressed to the AP 102 can be reliably transmitted while placing priority over radio wave transmission from the ND 111.

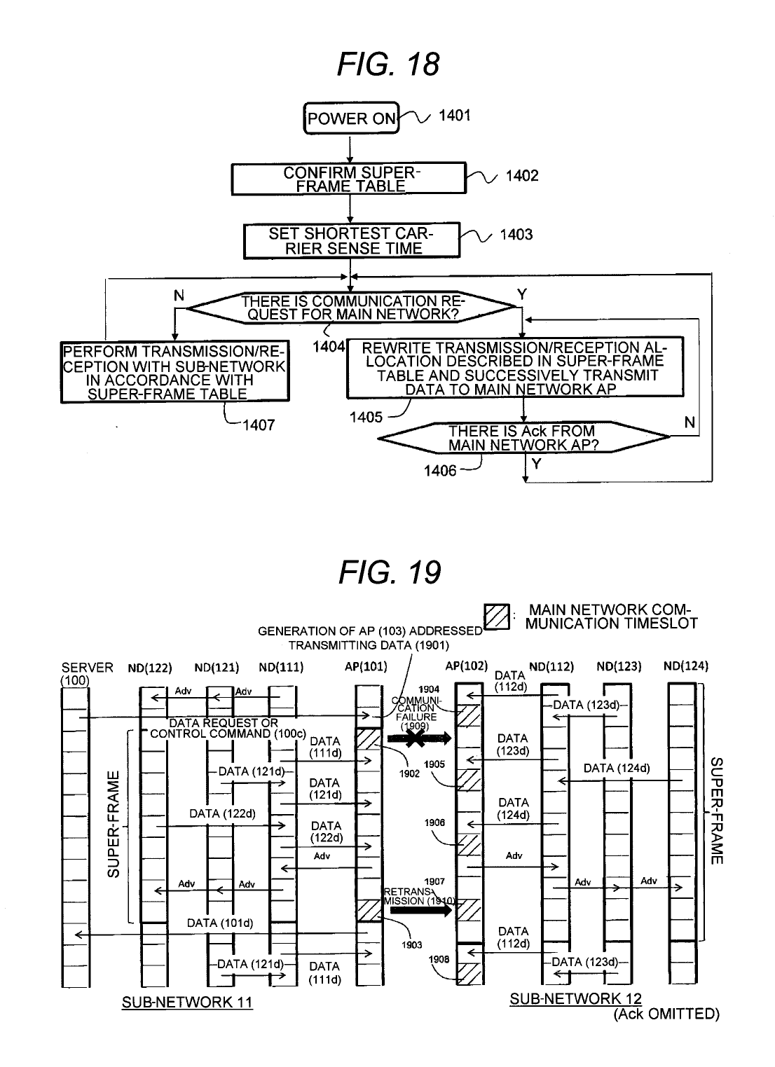

FIG. 18 is an operation flowchart of an AP in this example.

If the power is turned on (1401), the AP confirms the superframe table (1402). Next, the carrier sense time is set to be shortest (1403), and the procedure is changed to a communication mode. In the communication mode, the presence/absence of a communication request for the main network (AP) is confirmed (1404). When there is a communication request, the superframe table 806 is rewritten by the communication control unit 803, and successive transmission to the main network (AP) is performed (1406) until Ack is receivable. When there is no communication request for the main network (AP), transmission/reception with the ND of the sub-network is performed (1407) in accordance with the superframe table 806.

### EXAMPLE 6

This example illustrates an example of the invention when time synchronization by transmission/reception of the packet for time synchronization (Adv) is not established between the server 100 and the AP 101, the AP 102, or the AP 103 in the main network of FIG. 1, and each sub-network independently performs communications by the TDMA scheme in association with Example 5.

FIG. 19 shows a communication time chart in this example.

The superframe configuration in FIG. 19 is the same as FIG. 16 in Example 5.

In this example, main network communication timeslots (1902 to 1908) are arranged cyclically in the superframes of the AP 101 and the AP 102. In the example of FIG. 19, the AP 101 arranges the main network communication timeslots in the timeslot (1902) and the timeslot (1903), and the AP 102 arranges the main network communication timeslots in the timeslots (1904), (1905), (1906), and (1907).

If transmitting data addressed to the AP 102 is generated (1901), while the AP 101 transmits data to the AP 102 in the timeslot (1902), since the AP 102 is not allocated to the main network communication timeslot in this timeslot, communication failure (1909) occurs.

However, if the AP 101 retransmits the same data in the timeslot (1903) (1910), the AP 102 is also allocated to the main network communication timeslot (1907) in this timeslot, whereby communication can be successful.

### EXAMPLE 7

This example illustrates an example of the invention when time synchronization by transmission/reception of the packet for time synchronization (Adv) is not established between the server 100 and the AP 101, 102, or 103 in the main network of FIG. 1, and each sub-network independently performs communication by the CSMA scheme.

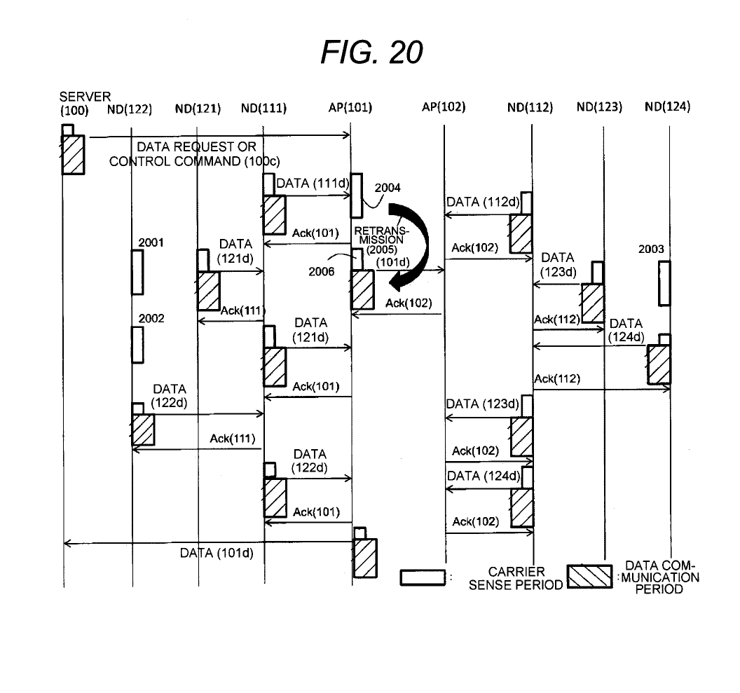

FIG. 20 shows a communication time chart in this example. Each ND spontaneously performs carrier sense by the CSMA scheme over a random period, and when no radio wave is detected, transmits or transfers data to the AP 101 or the AP 102.

In the example of FIG. 20, during the carrier sense period (2001) and (2002) of the ND 122 and the carrier sense period (2003) of the ND 124, carrier sense is performed, and as a result, since the transmission radio waves of data (121d), data (122d), and data (123d) are detected, immediate data transmission is put off.

While the AP 101 transmit data addressed to the AP 102 immediately after carrier sense is performed in carrier sense (2004), if data (111d) of the ND (111) is detected in carrier sense (2004), data transmission addressed to the AP 102 is put off until the transmission of data (111d) of the ND 111 is completed, and retransmission is attempted.

In the retransmission (2005), since no transmission radio wave is detected by carrier sense (2006), transmission of data (101d) addressed to the AP 102 is performed, and Ack (102) is received from the AP 102.

### EXAMPLE 8

In this example, data communication of the main network or means for transmitting high-priority data, such as emergency information or control information, while giving priority over normal power monitoring information main network will be described in association with Example 6.

FIG. 21 is a communication time chart when, similarly to FIG. 20, both the main network and the sub-network perform communication by the CSMA scheme.

In the example of the FIG. 20, since the carrier sense time immediately before the AP 101 transmits data (101d) to the AP 102 is greater than the carrier sense time of the ND 111, data addressed to the AP 102 is retransmitted. However, transmission delay occurs in high-priority data.

Accordingly, in this example, as shown in FIG. 13 described in Example 3, the shortest carrier sense time (2101) in which, at the time of priority data transmission, the previous carrier sense time is smaller than the time which can be set to be random is introduced. With this, it becomes possible to suppress data transmission of the ND 111 having low priority as shown in FIG. 21 and to transmit priority data (101d) with minimum latency.

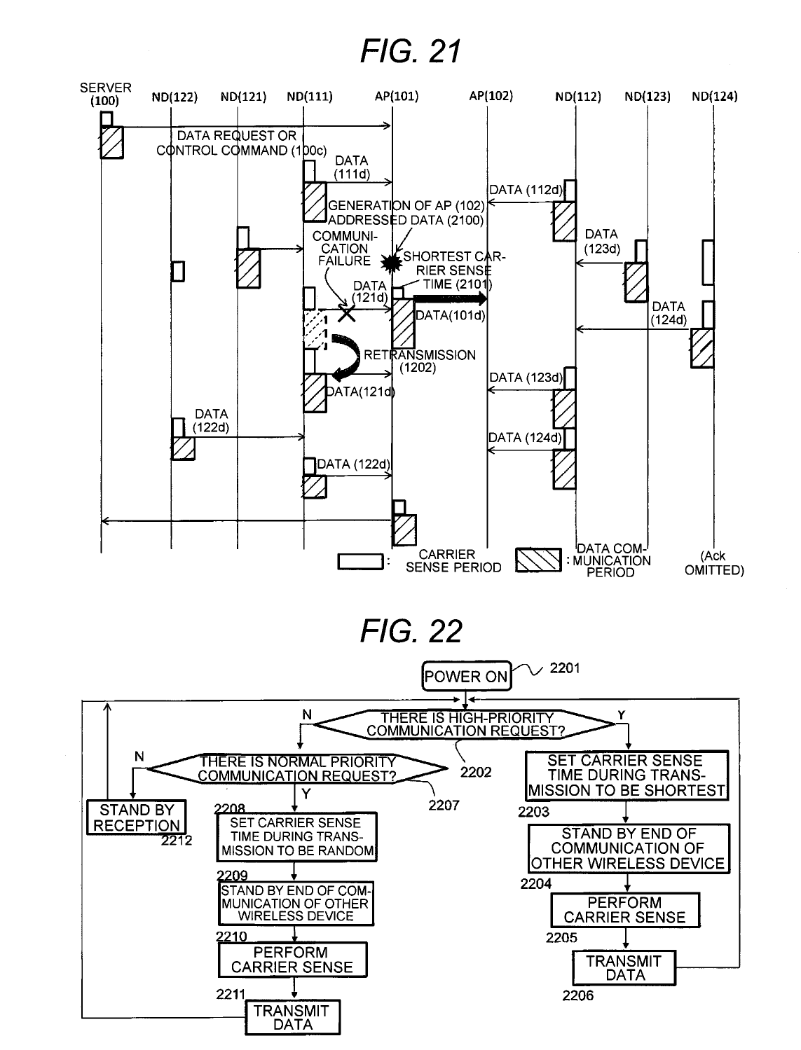

FIG. 22 is an operation flowchart of the AP in this example. If the power is turned on (2201), the AP confirms the presence/absence of a high-priority communication request (2202). When a high-priority data transmitting request is generated, the carrier sense time during transmission is set to be shortest (2203). It stands by the end of transmission of the other wireless device in communication (2204), and after the transmission ends, carrier sense is performed (2205). The condition that no radio wave is detected by carrier sense is confirmed, and high-priority data is transmitted (2206).

When there is no high-priority communication request in (2202), the presence/absence of a normal priority communication request is confirmed (2207). If there is no normal priority communication request, reception standby is performed.

If there is a normal priority communication request, first, the carrier sense time is set to be random (2208), it stands by the end of transmission of the other wireless device (2209), carrier sense is performed, and if no radio wave is detected, data is transmitted (2211).

### Supplementary Note

(1) An example where the main network 1 and the sub-networks 12, 13, and 14 in all of Examples perform communication by different communication frequency channels to avoid mutual interference and to realize wireless communication with low latency is included in Examples.

(2) An example where a synchronized scheme/asynchronized scheme is switched depending on a system utilization location and traffic of wireless communication such that a synchronized scheme is used at a location, such as a city area or a residential area, where the density of wireless communication devices is high, and an asynchronized scheme is used at a location, such as a mountain area, where the density of wireless communication devices is low is included in Examples.

What is claimed is:

1. A wireless communication system,
wherein a wireless communication main network which has a plurality of wireless access points including first and second wireless access points is configured,
a first wireless communication sub-network which has the first wireless access point and at least either of a plurality of first wireless terminal devices or first wireless rooter terminals is configured,
a second wireless communication sub-network which has the second wireless access point and at least either of a plurality of second wireless terminal devices or second wireless rooter terminals is configured,
the wireless communication main network and the first and second wireless communication sub-networks configure a single wireless communication network system,
during a period in which wireless communication is being performed between the first and second wireless access points, wireless communication in the first wireless communication sub-network and the second wireless communication sub-network is made to stand by, and
during the time other than the period in which the wireless communication is being performed between the first and second wireless access points, wireless communication in at least one of the first wireless communication sub-network and the second wireless communication sub-network is performed.

2. The wireless communication system according to claim 1,
wherein time synchronization of the wireless communication timing between the plurality of wireless access points including the first and second wireless access points is done, and wireless communication is performed while matching the transmission/reception timing of the wireless communication in the wireless communication main network.

3. The wireless communication system according to claim 2,
wherein time synchronization between the devices of the wireless access points in the first wireless communication sub-network or the second wireless communication sub-network and at least one of the wireless terminal devices or the wireless rooter terminals is done to perform communication while matching the transmission/reception timing, the communication timing between the devices is divided in terms of time, wireless communication is performed between certain devices in a first timeslot, and wireless communication is performed between different devices in a second timeslot different from the first timeslot.

4. The wireless communication system according to claim 3,
wherein, in the communication timeslot allocated to the wireless communication main network, during data transmission from one wireless access point,
the carrier sense time of the wireless access point is set to be smaller than the carrier sense time of all other wireless access points in the wireless communication network system, the wireless terminal devices, and the wireless rooter terminals.

5. The wireless communication system according to claim 3,
wherein different wireless communication frequencies are used in the wireless communication main network and the first and second wireless communication sub-networks to avoid interference between the sub-networks.

6. The wireless communication system according to claim 2,
wherein communication is performed by a polling scheme or an asynchronous CSMA scheme during wireless communication of at least either of the first or second wireless communication sub-network,
the first or second wireless terminal device or the first or second wireless rooter terminal transmits the requested data to the first or second wireless access point in response to a data request from the first or second wireless access point, and
the first or second wireless access point performs polling of other terminals upon confirmation of the arrival of data.

7. The wireless communication system according to claim 6,
wherein, in the communication timeslot allocated to the wireless communication main network, during data transmission from one wireless access point,
the carrier sense time of the wireless access point is set to be smaller than the carrier sense time of all other wireless access points in the wireless communication network system, the wireless terminal devices, and the wireless rooter terminals.

8. The wireless communication system according to claim 6,
wherein different wireless communication frequencies are used in the wireless communication main network and the first and second wireless communication sub-networks to avoid interference between the networks.

9. The wireless communication system according to claim 1,
wherein wireless communication in the first wireless communication sub-network and wireless communication in the second wireless communication sub-network are asynchronized without time synchronization.

10. The wireless communication system according to claim 9,
wherein wireless communication in the first and second wireless communication sub-network is time synchronization communication by a TDMA scheme.

11. The wireless communication system according to claim 10,
wherein, for the purpose of enabling wireless communication between the plurality of wireless access points, at the wireless access point on a transmission side, processing for replacing communication timeslot data of a period until communication between the wireless access points is established with communication timeslot data for communication between the wireless access points is performed.

12. The wireless communication system according to claim 11,
wherein, in the communication timeslot allocated to the wireless communication main network, during data transmission from one wireless access point,
the carrier sense time of the wireless access point is set to be smaller than the carrier sense time of all other wireless access points in the wireless communication network system, the wireless terminal devices, and the wireless rooter terminals.

13. The wireless communication system according to claim 11,
wherein different wireless communication frequencies are used in the wireless communication main network and the first and second wireless communication sub-networks to avoid interference between the sub-networks.

14. The wireless communication system according to claim 10,
wherein, for the purpose of enabling wireless communication between the first and second wireless access points,
a first superframe is allocated into the first wireless access point, and a second superframe is allocated into the second wireless access point, and
timeslot data for communication of the timeslots for main network wireless communication in the superframes is different between the first superframe and the second superframe.

15. The wireless communication system according to claim 9,
wherein wireless communication by a CSMA scheme is performed independently in the first wireless communication sub-network and the second wireless communication sub-network.

16. The wireless communication system according to claim 15,
wherein, during maximum priority data transmission at the timing,
the carrier sense time of the wireless access point is set to be smaller than the carrier sense time of all other wireless access points in the wireless communication network system, the wireless terminal devices, and the wireless rooter terminals.

17. The wireless communication system according to claim 15,
wherein different wireless communication frequencies are used in the wireless communication main network and the first and second wireless communication sub-networks to avoid interference between the sub-networks.
